(19) United States
(12) Patent Application Publication
(10) Pub. No.: US 2014/0234693 A1
(43) Pub. Date: Aug. 21, 2014

(54) NONAQUEOUS ELECTROLYTE BATTERY SEPARATOR AND NONAQUEOUS ELECTROLYTE BATTERY

(71) Applicants: Tomonobu Tsujikawa, Tokyo (JP); Masayasu Arakawa, Tokyo (JP); Tadashi Yoshiura, Tokyo (JP)

(72) Inventors: Tomonobu Tsujikawa, Tokyo (JP); Masayasu Arakawa, Tokyo (JP); Tadashi Yoshiura, Tokyo (JP)

(21) Appl. No.: 14/342,916

(22) PCT Filed: Sep. 5, 2012
(86) PCT No.: PCT/JP2012/072560

§ 371 Date: May 6, 2014

(30) Foreign Application Priority Data
Sep. 5, 2011 (JP) 2011-193288

(51) Int. Cl. H01M 2/16; H01M 10/42

(52) U.S. Cl. CPC H01M 2/1686; H01M 2/1653; H01M 10/4235
USPC 429/144

(57) ABSTRACT

Provided herein is a nonaqueous electrolyte battery separator capable of rendering a battery flame-retardant and suppressing a reduction in battery performance is provided. A porous front-side protective layer 47 is formed on a front surface 45A of a porous base material 45 made of a polyolefin-based resin. The front-side protective layer 47 protects the porous base material 45 such that the porous base material 45 is not thermally deformed or thermally contracted. A porous front-side flame retardant layer 49 is formed on the front-side protective layer 47. The front-side flame retardant layer 49 contains solid flame retardant having a melting point lower than the ignition temperature of a nonaqueous electrolyte.

### TECHNICAL FIELD

The present invention relates to a nonaqueous electrolyte battery separator and a nonaqueous electrolyte battery including the separator.

### BACKGROUND ART

Nonaqueous electrolyte batteries such as lithium ion secondary batteries include a separator formed from a thermoplastic resin such as polyethylene in consideration of insulation, solvent resistance, and so forth. If the internal temperature of the nonaqueous electrolyte battery rises, the separator made of a thermoplastic resin may be easily thermally deformed or thermally contracted to cause a short circuit through the separator between electrodes. In order to prevent thermal deformation or thermal contraction of the separator, the nonaqueous electrolyte battery according to the related art includes a protective layer formed on the front surface of the separator and containing a heat-resistant material such as alumina particles.

In the nonaqueous electrolyte batteries, a volatile organic solvent that is easily ignitable is used for a nonaqueous electrolyte. Thus, when an abnormal amount of heat is generated such as when the nonaqueous electrolyte battery is placed in a high-temperature environment or overcharged or overdischarged, the battery may generate fire, smoke, or the like because of combustion of the nonaqueous electrolyte. In a separator described in Patent Document 1 (JP2010-050076A), a heat-resistant porous layer (protective layer) is formed on a surface of a porous base material. In the separator, voids in the heat-resistant porous layer are formed by a template agent that serves as flame retardant for an electrolyte when dissolved in the electrolyte. That is, a plurality of voids are formed in the heat-resistant porous layer when the template agent is dissolved in the electrolyte. In the nonaqueous electrolyte battery including the separator, the dissolved template agent serves as flame retardant to suppress generation of fire or smoke when an abnormal amount of heat is generated.

### RELATED-ART DOCUMENT

### Patent Document

Patent Document 1: JP2010-050076A

### SUMMARY OF INVENTION

### Technical Problem

However, the plurality of voids, which make the heat-resistant porous layer (protective layer) of the separator porous, are formed as a result of the template agent being dissolved in an electrolyte to serve as flame retardant. Therefore, in the separator according to the related art, the mechanical strength of the heat-resistant porous layer (protective layer), which remains after the template agent is dissolved, is reduced. That is, in the nonaqueous electrolyte battery including the separator according to the related art, the mechanical strength of the separator is reduced after the template agent is dissolved in the electrolyte, which makes the separator easily thermally deformable or thermally contractible. As a result, a partial short circuit may be caused through the separator between electrodes to reduce the battery performance.

An object of the present invention is to provide a nonaqueous electrolyte battery separator capable of rendering a battery flame-retardant and suppressing a reduction in battery performance.

Another object of the present invention is to provide a nonaqueous electrolyte battery capable of suppressing a reduction in battery performance even if the battery is rendered flame-retardant.

### Solution to Problem

The present invention improves a nonaqueous electrolyte battery separator in which a porous front-side protective layer is formed on a front surface of a porous base material to protect the porous base material such that the porous base material is not thermally deformed or thermally contracted. In the nonaqueous electrolyte battery separator according to the present invention, the porous base material is formed from a polyolefin-based resin having a large number of continuous minute holes. In addition, the front-side protective layer is formed from a material that imparts heat resistance to the porous base material such that the porous base material is not thermally deformed or thermally contracted.

In the present invention, a flame retardant layer is formed on a front surface of the front-side protective layer, and the flame retardant layer contains flame retardant that is solid at normal temperature and that has a melting point lower than an ignition temperature of a nonaqueous electrolyte. The solid flame retardant contained in the flame retardant layer is melted when the battery generates an abnormal amount of heat to be dispersed in the nonaqueous electrolyte to provide a function of trapping radicals (or active species) released from a positive active material. When the battery is used at a normal temperature (when an abnormal amount of heat is not generated), the solid flame retardant is kept solid in the flame retardant layer, but does not impair the ion permeability because the flame retardant layer is porous.

If a front-side flame retardant layer containing solid flame retardant having a melting point that does not allow the flame retardant to be dissolved when the battery is at a normal temperature is formed on the front surface of a front-side protective layer as in the present invention, a flame retardant layer that is separate from a protective layer can be formed on the front surface of a separator. That is, flame retardant is not contained in the protective layer. Therefore, the mechanical strength of the protective layer is not reduced even if a part or all of the flame retardant is melted or decomposed because of a rise in internal temperature, which prevents thermal deformation or thermal contraction of the separator. As a result, a reduction in battery performance is suppressed since a short circuit is unlikely to be caused through the separator between electrodes. Moreover, when an abnormal amount of heat is generated, the flame retardant in the flame retardant layer provided separately from the protective layer is dissolved in a nonaqueous electrolyte to trap radicals generated in the battery to exhibit flame retardant properties. Thus, according to the present invention, a nonaqueous electrolyte battery can be rendered flame-retardant while maintaining the battery performance.

In the specification, the term “protective layer” refers to a front-side protective layer and/or a back-side protective layer, and the term “flame retardant layer” refers to a front-side flame retardant layer and/or a back-side flame retardant layer.

In addition to the front-side protective layer formed on the front surface of the porous base material as discussed above, a porous back-side protective layer that is separate from the front-side protective layer may be formed on a back surface of the porous base material. As with the front-side protective layer formed on the front surface of the porous base material, the back-side protective layer is also formed from a material that imparts heat resistance to the porous base material such that the porous base material is not thermally deformed or thermally contracted. If such a structure is adopted, a protective layer is formed not only on the front surface but also on the back surface of the porous base material. Therefore, the heat resistance of the separator can be further improved while maintaining the function of suppressing thermal contraction of the separator. Further, a porous back-side flame retardant layer containing solid flame retardant having a melting point lower than an ignition temperature of a nonaqueous electrolyte may be formed on the back surface of the porous base material separately from the porous front-side flame retardant layer. If the back-side protective layer is formed on the back surface of the porous base material, the back-side flame retardant layer is formed on a front surface of the back-side protective layer. If the back-side flame retardant layer is formed on the back side of the separator in addition to the front side thereof, the flame retardant properties of the battery can be enhanced not only on the front side but also on the back side of the separator. If the back-side protective layer is not formed, the back-side flame retardant layer may be directly formed on the back surface of the porous base material.

The solid flame retardant contained in the front-side flame retardant layer and the back-side flame retardant layer which are porous is preferably a cyclic phosphazene compound having a melting point equal to or more than 90° C. The cyclic phosphazene compound having such a melting point is kept solid when the battery is normal (when the internal temperature is leas than 90° C.). Therefore, the flame retardant itself does not impair the ion permeability, or the mechanical strength of the front-side flame retardant layer or the back-side flame retardant layer is not reduced. When the flame retardant is dissolved, the temperature of the battery has reached an abnormally high temperature. Therefore, the battery will no longer be used as a battery, and there will be no problem if the mechanical strength of the front-side flame retardant layer or the back-side flame retardant layer is reduced. Therefore, use of the cyclic phosphazene compound as the flame retardant can render the battery flame-retardant while maintaining the battery performance.

The cyclic phosphazene compound used as the flame retardant is preferably a cyclic phosphazene compound represented by the formula (NPR₂)₃ or (NPR₂)₄, where R is a halogen element or a monovalent substituent, the monovalent substituent being an alkoxy group, an aryloxy group, an alkyl group, an aryl group, an amino group, an alkylthio group, or an arylthio group. The cyclic phosphazene compound having such a chemical structure has a melting point equal to or more than 90° C., and thus can be kept solid in the flame retardant layer when the battery is normal (when the internal temperature is less than 90° C.)

The content of the cyclic phosphazene compound is preferably 2.5 to 15.0% by weight with respect to the weight of an active material contained in an electrode provided to face the flame retardant layer (the front-side flame retardant layer and/or the back-side flame retardant layer). If the content of the flame retardant in the flame retardant layer or the other flame retardant layer is 2.5 to 15.0% by weight with respect to 100% by weight of the active material, the battery can be rendered flame-retardant to a practically acceptable degree without significantly impairing the ion permeability in the separator (without significantly reducing the battery performance such as the discharge capacity).

The surface area of the flame retardant layer may be equal to or more than 60% of the surface area of the nonaqueous electrolyte battery separator. If the flame retardant layer is formed such that the surface area of the flame retardant layer is at least 60% with respect to the surface area of the nonaqueous electrolyte battery separator being 100%, a portion of the surface of the separator (or the protective layer) on which the flame retardant layer is not formed enhances the ion permeability to increase the ion permeability of the separator as a whole to improve the battery performance. In addition, partially forming the flame retardant layer can substantially reduce the use amount of the flame retardant, and thus can reduce the production cost. If the surface area of the flame retardant layer is less than 60% with respect to the surface area of the separator being 100%, the content of the flame retardant contained in the flame retardant layer is too small to obtain sufficient flame retardant properties.

In order to form the front-side protective layer and the back-side protective layer, fillers (such as alumina particles) may be used. The fillers are bound to the front surface of the porous base material by a binder, and maintain a large number of voids or cavities inside the protective layer after a solvent is volatilized. Use of such fillers can form a porous protective layer including a plurality of continuous voids to provide ion permeability. In addition, the fillers preferably have a melting point equal to or more than 120° C. The fillers having such a melting point are kept solid even if the internal temperature of the battery rises to be equal to or more than 120° C., which is the pyrolysis temperature of the nonaqueous electrolyte, to prevent thermal deformation or thermal contraction of the porous base material.

If the nonaqueous electrolyte battery separator according to the present invention is used to form a nonaqueous electrolyte battery, the mechanical strength of the front-side protective layer and/or the back-side protective layer of the separator is not varied after assembly of the battery. Thus, the battery performance is not reduced when the battery is in a normal state. After the temperature of the battery rises to an abnormal temperature so that a part or all of the flame retardant is melted or decomposed, the battery will no longer be used as a battery, and there will be no problem if the mechanical strength of the flame retardant layer is reduced.

In nonaqueous electrolyte batteries such as lithium ion secondary batteries, the positive electrode often becomes hot when the battery generates an abnormal amount of heat to ignite the nonaqueous electrolyte inside the battery. Thus, if the nonaqueous electrolyte battery separator according to the present invention in which the front-side protective layer and the front-side flame retardant layer are formed on the front surface of the porous base material is used for a nonaqueous electrolyte battery, the nonaqueous electrolyte battery separator is preferably disposed such that the front-side flame retardant layer faces a positive electrode and the back surface of the porous base material faces a negative electrode. With such a configuration, the mechanical strength of the front-side protective layer is not reduced, which suppresses thermal deformation and thermal contraction of the separator. Furthermore, the flame retardant dissolved from the front-side flame retardant layer exhibits flame retardant properties to trap radicals generated from the positive electrode at a front surface of the positive electrode. As a result, the battery can be rendered flame-retardant without reducing the battery performance at normal times.

In nonaqueous electrolyte batteries such as lithium ion secondary batteries, in addition, the negative electrode occasionally becomes hot as with the positive electrode, or becomes hotter than the positive electrode, when the battery generates an abnormal amount of heat to ignite the battery. In this case, the nonaqueous electrolyte battery separator according to the present invention including the front-side flame retardant layer and the negative-side flame retardant layer may be used.

### BRIEF DESCRIPTION OF DRAWINGS

FIG. 1 is a schematic view illustrating the inside of a nonaqueous electrolyte battery (lithium ion secondary battery) including a nonaqueous electrolyte battery separator according to the present invention in a transparent state.

FIG. 2 is a cross-sectional view of a nonaqueous electrolyte battery separator according to a first embodiment of the present invention.

FIG. 3 is a cross-sectional view of a nonaqueous electrolyte battery separator according to a second embodiment of the present invention.

FIG. 4 is a cross-sectional view of a nonaqueous electrolyte battery separator according to a third embodiment of the present invention.

FIG. 5 is a cross-sectional view of a nonaqueous electrolyte battery separator according to a fourth embodiment of the present invention (an example in which a protective layer is formed on the front surface and the back surface of a porous base material).

FIG. 6 is a graph illustrating the discharge capacity of the nonaqueous electrolyte battery separators according to the present invention.

FIG. 7 is a view of a nonaqueous electrolyte battery separator according to an example of the present invention (an example in which a flame retardant layer is formed over the entire front surface of a protective layer) as seen from the front surface side of the porous base material.

FIG. 8 is a view of a nonaqueous electrolyte battery separator according to an example of the present invention (an example in which stripes of a flame retardant layer are formed on apart of the front surface of a protective layer) as seen from the front surface side of the porous base material.

### DESCRIPTION OF EMBODIMENTS

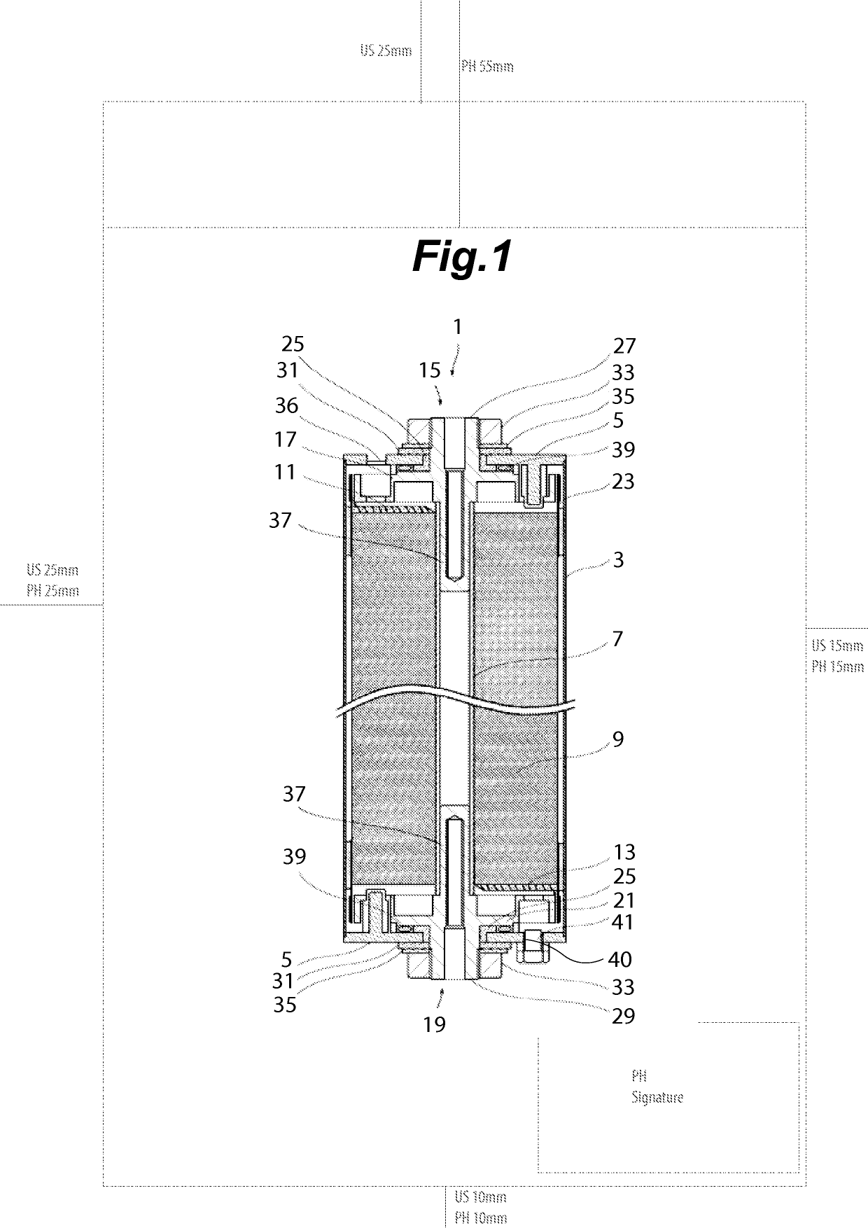

Embodiments of the present invention will be described in detail below. FIG. 1 is a schematic view illustrating the inside of a lithium ion secondary battery as a nonaqueous electrolyte battery according to an embodiment of the present invention in a transparent state. A lithium ion secondary battery (cylindrical battery) 1 includes, as a casing, a battery container 3 in a bottomless cylinder shape, and two disc-shaped battery lids 5 disposed at both end portions of the battery container 3. An electrode group 9 is housed in the casing (the battery container 3 and the battery lids 5). The electrode group 9 is infiltrated with a nonaqueous electrolyte (not illustrated). In the electrode group 9, a positive electrode and a negative electrode (not illustrated) are disposed around a hollow cylindrical axial core 7 made of polypropylene via separators (separators 43, 143, 243, 343) to be described in detail later. In the embodiment, the lithium ion secondary battery 1 was fabricated as follows.

### [Fabrication Procedure]

The lithium ion secondary battery 1 according to the embodiment will be described in further detail, and the fabrication procedure of the lithium ion secondary battery 1 will be described.

### [Fabrication of Positive Electrode]

The positive electrode constituting the electrode group 9 was fabricated as follows. Lithium manganate (LiMn₂O₄) powder as a positive active material, flake graphite (average grain size: 20 μm) as a conducting agent, and polyvinylidene fluoride (PVDF) as a binding agent were mixed, and N-methyl-2-pyrrolidone (NMP) as a dispersion solvent was added to the mixture. After that, the mixture was kneaded to prepare slurry. The slurry was applied to both surfaces of an aluminum foil (positive current collector) with a thickness of 20 μm to form a positive mixture layer. The slurry was not applied to one of side edge portions (width: 50 mm) of the aluminum foil that extend in the longitudinal direction of the aluminum foil. After that, the aluminum foil was dried, pressed, and cut to obtain a positive electrode with a width of 389 mm and a length of 5100 mm. The thickness of the positive mixture layer (excluding the thickness of the current collector) was 275 μm, and the amount of the positive active material applied to each surface of the current collector was 350 g/m².

The unapplied portion with a width of 50 mm formed in the positive electrode was notched to remove some portions of the unapplied portion. The remaining rectangular portions (in a comb-like shape) were used as positive electrode lead pieces 11 for current collection. The width of the positive electrode lead pieces 11 was about 10 mm, and the interval between adjacent positive electrode lead pieces 11 was about 20 mm.

### [Fabrication of Negative Electrode]

Meanwhile, the negative electrode constituting the electrode group 9 was fabricated as follows. Artificial graphite powder as a negative active material and PVDF as a binding agent were mixed, and NMP as a dispersion solvent was added to the mixture. After that, the mixture was kneaded to prepare slurry. The slurry was applied to both surfaces of a rolled copper foil (negative current collector) with a thickness of 10 μm to form a negative mixture layer. The slurry was not applied to one of side edge portions (width: 50 mm) of the copper foil that extend in the longitudinal direction of the copper foil. After that, the copper foil was dried, pressed, and cut to obtain a negative electrode with a width of 395 mm and a length of 5290 mm. The thickness of the negative mixture layer (excluding the thickness of the current collector) was 201 μm, and the amount of the negative active material applied to each surface of the current collector was 130.8 g/m².

The unapplied portion with a width of 50 mm formed in the negative electrode was notched to remove some portions of the unapplied portion. The remaining rectangular portions were used as negative electrode lead pieces 13 for current collection. The width of the negative electrode lead pieces 13 was about 10 mm, and the interval between adjacent negative electrode lead pieces 13 was about 20 mm.

The width of a portion of the negative electrode to which the negative active material was applied was larger than the width of a portion of the positive electrode to which the positive active material was applied such that no positional deviation occurs between the applied portion of the positive electrode and the applied portion of the negative electrode, which face each other, also in the width direction of the positive electrode and the negative electrode.

### [Fabrication of Electrode Group]

The positive electrode and the negative electrode were interposed between two porous separators with a thickness of 36 μm and mainly made from polyolefin-based polyethylene, and wound to prepare the electrode group 9. A total of four separators were used. The positive electrode, the negative electrode, and the separators were wound with the distal-end portions of the separators first thermally welded to the axial core 7 to align the positive electrode, the negative electrode, and the separators to reduce the possibility of winding deviation. The positive electrode lead pieces 11 and the negative electrode lead pieces 13 were disposed on opposite sides of the electrode group 9. The positive electrode, the negative electrode, and the separators were cut to an appropriate length during winding such that the diameter of the electrode group 9 was 63.6±0.1 mm.

### [Fabrication of Battery]

The positive electrode lead pieces 11 led out from the positive electrode were gathered into a bundle, and deformed to be bent. After that, the positive electrode lead pieces 11 were brought into contact with the peripheral edge of a flange portion 17 of a positive electrode pole 15. The positive electrode lead pieces 11 and the peripheral edge of the flange portion 17 were welded (joined) using an ultrasonic welding device to be electrically connected to each other. Also for the negative electrode, the negative electrode lead pieces 13 and the peripheral edge of a flange portion 21 of a negative electrode pole 19 were ultrasonically welded to be electrically connected to each other.

After that, the flange portion 17 of the positive electrode pole 15, the flange portion 21 of the negative electrode pole 19, and the entire outer peripheral surface of the electrode group 9 were covered by an insulating coating 23. An adhesive tape made of polyimide, to one surface of which an adhesive made of hexamethacrylate was applied, was used as the insulating coating 23. The number of windings of the adhesive tape was adjusted such that the outer peripheral portion of the electrode group 9 was covered by the insulating coating 23 and was slightly smaller than the inside diameter of the battery container 3, which was made of stainless steel. After that, the electrode group 9 was inserted into the battery container 3. The battery container 3 according to the embodiment had an outside diameter of 67 mm and an inside diameter of 66 mm.

Next, a first ceramic washer 25 was fitted with the distal end of each of a terminal portion 27 (positive electrode) and a terminal portion 29 (negative electrode) to abut against the outer surface of the battery lid 5. Then, a flat second ceramic washer 31 was placed on the battery lid 5 with each of the terminal portions 27 and 29 passing through the second ceramic washer 31.

After that, the peripheral edge of the battery lid 5 was fitted with an opening portion of the battery container 3, and the entire portion of contact between the battery lid 5 and the battery container 3 was laser-welded. At this time, the terminal portions 27 and 29 each project out of the battery container 3 through a hole formed in the center of the battery lid 5. Then, a metal washer 35, which was smoother than the bottom surface of a nut 33 made of metal, was fitted with each of the terminal portions 27 and 29 to abut against the second ceramic washer 31. One of the battery lids 5 (the upper one in FIG. 1) was provided with a cleavage valve 36 configured to open when the internal pressure of the battery rose. The opening pressure was set to 13 to 18 kg/cm². Unlike so-called small consumer lithium ion secondary batteries, the lithium ion secondary battery 1 according to the embodiment was not provided with a current cut-off mechanism configured to operate in response to a rise in pressure inside the battery.

The nut 33 was screwed to each of the terminal portions 27 and 29 and tightened to fix the battery lid 5 between the flange portion 17 and the nut 33 via the metal washer 35, the first ceramic washer 25, and the second ceramic washer 31. The fastening torque value was set to 6.86 N·m. An O ring 39 made of rubber (EPDM) was interposed between the back surface of the battery lid 5 and a projecting portion 37. The O ring 39 was compressed when the nut 33 was tightened to shut off power generating elements etc. inside the battery container 3 from outside air.

Next, a predetermined amount of a nonaqueous electrolyte was injected into the battery container 3 from a liquid injection port 40 formed in the other battery lid 5 (the lower one in FIG. 1). After that, the liquid injection port 40 was blocked by a liquid injection plug 41 to complete the cylindrical lithium ion secondary battery 1.

### [Fabrication of Separator]

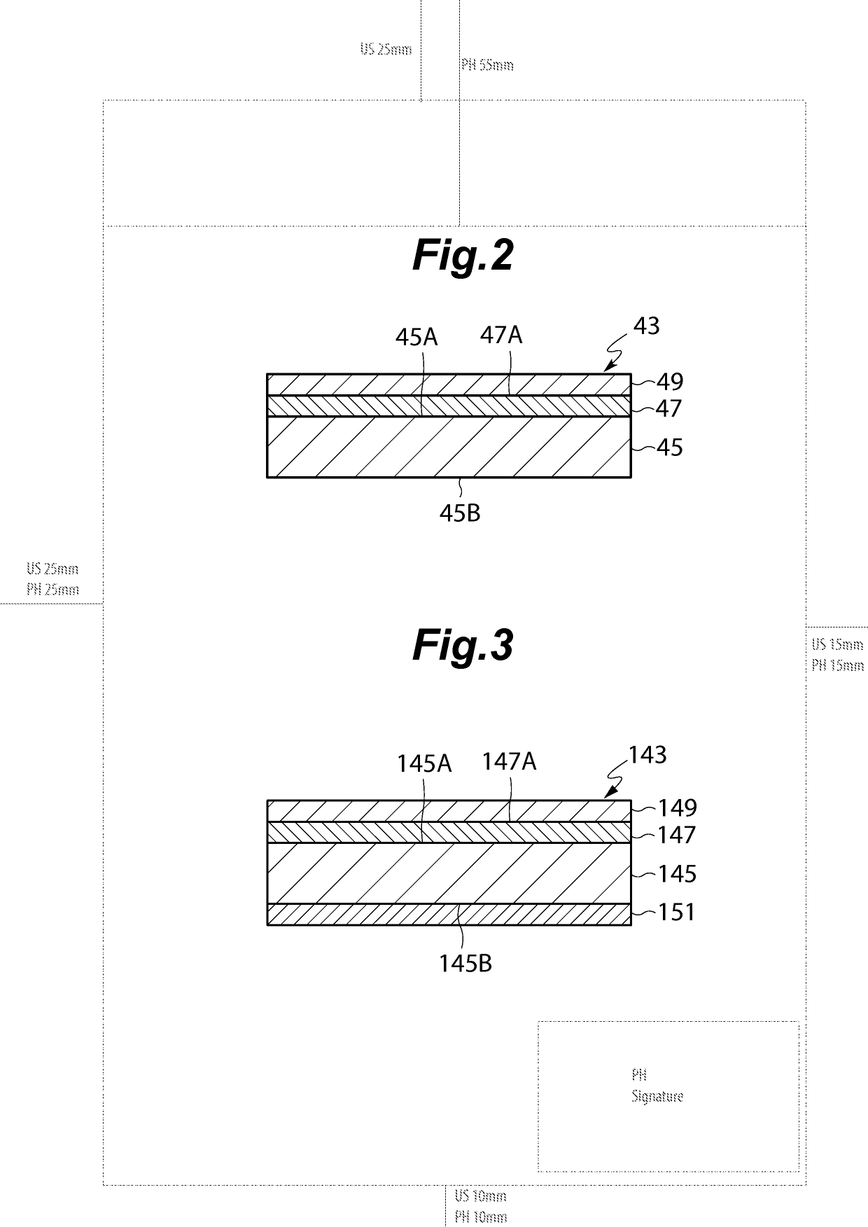

FIG. 2 is an enlarged cross-sectional view of a separator 43 according to a first embodiment of the present invention as cut in the thickness direction. The separator 43 of FIG. 2 is structured to include a porous base material 45 made of a polyolefin-based resin, a front-side protective layer 47 formed on the porous base material 45, and a front-side flame retardant layer 49 formed on the front-side protective layer 47. In the example, first, a separator sheet obtained by forming a porous protective layer (base material of the front-side protective layer 47) with a thickness of 5 μm on the front surface of a sheet substrate (base material of the porous base material 45) with a thickness of 25 μm was prepared. The separator sheet was a composite sheet including a sheet substrate made of a porous polyolefin-based resin (polyethylene), and a porous front-side protective layer formed on the front surface of the sheet substrate and containing fillers of alumina particles bound to the front surface of the sheet substrate.

In the example, a front-side flame retardant layer was formed on the front surface of the separator sheet as a composite sheet. In order to form a front-side flame retardant layer, first, a solid cyclic phosphazene compound [Phoslyte (registered trademark) manufactured by Bridgestone Corporation] with a melting point of 112° C. as flame retardant, polyvinylidene fluoride as a binder, and N-methylpyrrolidone as a solvent were mixed by a weight ratio of 20:20:60 to prepare slurry. The chemical structure of the cyclic phosphazene compound used is represented by the formula (NPR₂)₃, where R is a phenoxy group. The slurry was applied to the front surface of the front-side protective layer of the composite sheet to form an applied layer.

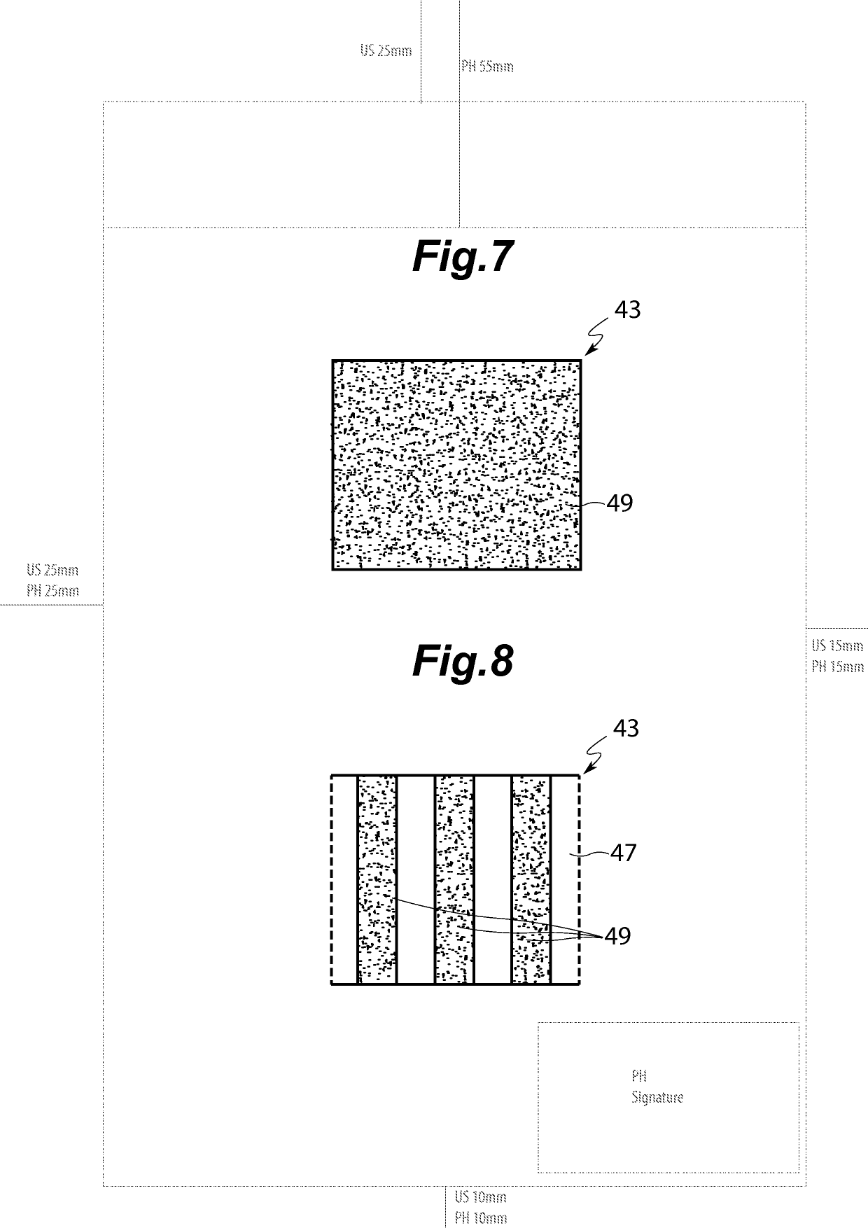

The applied layer was formed such that the slurry was applied to the composite sheet in an amount of 40 g/m². In addition, the applied layer was formed such that the front-side flame retardant layer 49 was applied over an area corresponding to 100% to 40% with respect to the surface area (area as seen in plan) of the front-side protective layer 47 of the separator 43 (see FIGS. 7 and 8). If the front-side flame retardant layer 49 was applied over an area corresponding to 80% to 40% with respect to the surface area of the front-side protective layer 47 of the separator 43, the applied layer was formed such that stripes of the front-side flame retardant layer 49 were formed on the front surface of the front-side protective layer 47 as illustrated in FIG. 8.

Next, the applied layer was dried under drying conditions at a drying temperature of 60° C. and for a drying time of three hours. After being dried, the applied layer formed on the front surface of the composite sheet was a porous layer in which a large number of continuous minute holes were formed therein, although not specifically illustrated. The cyclic phosphazene compound used in the embodiment was dissolved in the solvent, and thereafter precipitated in the drying process for the applied layer to be present as dispersed in a solid state in the front-side flame retardant layer 49. After the applied layer was dried, the sheet was cut to obtain the separator 43. In this way, the separator 43 in which the front-side protective layer 47 was formed on a front surface 45A of the porous base material 45 and the front-side flame retardant layer 49 was formed on a front surface 47A of the front-side protective layer 47 was obtained. In the separator 43 illustrated in FIG. 2, neither a protective layer nor a flame retardant layer was formed on a back surface 45A of the porous base material 45.

FIG. 3 illustrates a cross-sectional structure of a separator 143 according to a second embodiment of the present invention. The separator 143 illustrated in FIG. 3 has the same structure as that of the separator 43 of FIG. 2 except that a back-side flame retardant layer 151 is formed on a back surface 145B of a porous base material 145. Thus, elements of the separator 143 illustrated in FIG. 3 that are common to those of the separator 43 illustrated in FIG. 2 are denoted by reference numerals obtained by adding 100 to the reference numerals affixed to their counterparts of the separator 43 of FIG. 2 to omit their descriptions. To manufacture the separator 143 of FIG. 3, an applied layer containing the same flame retardant as that contained in the applied layer formed on the front surface of the composite sheet to form the separator 43 of FIG. 2 was also formed on the back surface of the composite sheet at the same time as the applied layer (which would form the front-side flame retardant layer after being dried) was formed on the front surface of the composite sheet. Then, the applied layers were dried under the same conditions as those for the separator 43 to obtain the separator 143.

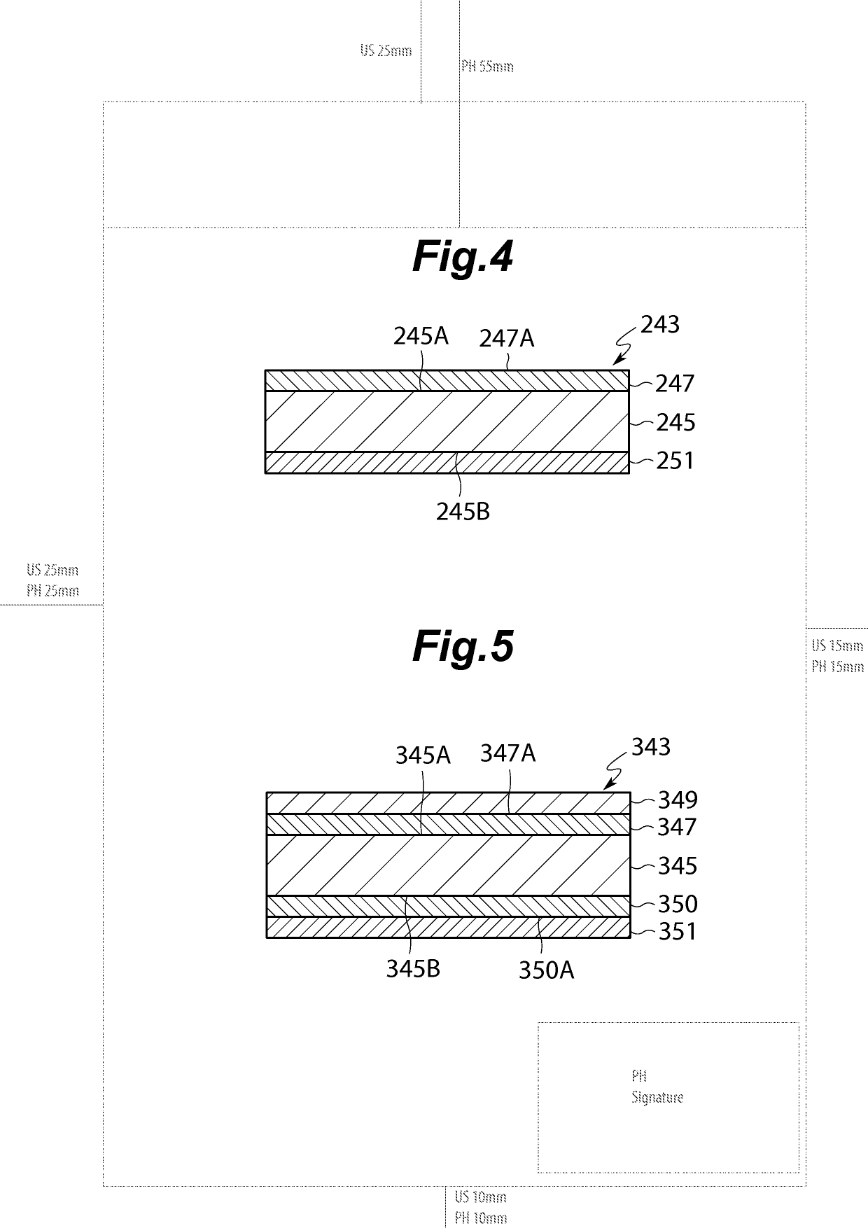

FIG. 4 illustrates a cross-sectional structure of a separator 243 according to a third embodiment of the present invention. The separator 243 has the same structure as that of the separator 143 of FIG. 3 except that a flame retardant layer (the front-side flame retardant layer 149 of FIG. 3) is not formed on a front surface 247A of a front-side protective layer 247. Thus, elements of the separator 243 illustrated in FIG. 4 that are common to the constituent elements of the separator 143 illustrated in FIG. 3 are denoted by reference numerals obtained by adding 100 to the reference numerals affixed to their counterparts illustrated in FIG. 3 to omit their descriptions. To manufacture the separator 243 structured as illustrated in FIG. 4, paste containing the flame retardant used to manufacture the separator 43 of FIG. 2 was applied to a back surface 245B of a porous base material 245 of the commercially available separator sheet used to manufacture the separator 43 of FIG. 2 to form an applied layer for the formation of a back-side flame retardant layer 251. Then, the applied layer was dried to form the back-side flame retardant layer 251 to obtain the separator 243.

FIG. 5 illustrates a cross-sectional structure of a separator 343 according to a fourth embodiment of the present invention. The separator 343 has the same structure as that of the separator 143 of FIG. 3 except that a back-side protective layer 350 is formed on a back surface 345B of a porous base material 345. Thus, elements of the separator 343 illustrated in FIG. 5 that are common to those of the separator 143 illustrated in FIG. 3 are denoted by reference numerals obtained by further adding 200 to the reference numerals affixed to their counterparts of the separator 143 of FIG. 3 to omit their descriptions. To manufacture the separator 343, paste containing the flame retardant used to manufacture the separator 43 of FIG. 2 was applied at the same time to the front surface and the back surface of a commercially available separator sheet with a protective layer on both surfaces, in which a porous protective layer was formed on both surfaces of a porous sheet substrate made of a polyolefin-based resin, to form an applied layer on both the surfaces. The applied layers on both the surfaces were dried under the same drying conditions as the drying conditions for the manufacture of the separator 43 of FIG. 2. Then, the separator 343 including a front-side flame retardant layer 349 provided on a front-side protective layer 397 and a back-side flame retardant layer 351 provided on a front surface 350A of the back-side protective layer 350 was obtained.

### [Fabrication of Cylindrical Battery]

The separator 43, 143, 243, or 343 was interposed between the positive electrode and the negative electrode fabricated as described above. The positive electrode, the negative electrode, and the separator 43 or the like were wound to fabricate the electrode group 9 with a battery capacity of about 50 Ah.

### [Preparation of Nonaqueous Electrolyte]

A mixed solvent was prepared by mixing ethylene carbonate and ethyl methyl carbonate by a volume ratio of 1:2. 1 Mol/L of lithium phosphate hexafluoride (LiPF₆) was dissolved in the mixed solvent to prepare a nonaqueous electrolyte.

### [Evaluation of Flame Retardant Properties—Nail Penetration Test]

The nonaqueous electrolyte battery (lithium ion secondary battery 1) fabricated as described above was evaluated for the flame retardant properties (battery safety). The flame retardant properties were evaluated by a nail penetration test. In the nail penetration test, first, a charge-discharge cycle was repeated twice at a current density of 0.1 mA/cm² in a voltage range of 4.2 to 2.7 V in an environment at 25° C., and further the battery was charged to 4.2 V. After that, a nail made of stainless steel and having a shaft with a diameter of 3 mm was vertically stuck in the center of a side surface of the battery at a speed of 0.5 cm/s at the same temperature of 25° C. to examine the internal temperature of the battery, whether or not the battery ignited or smoked, and whether or not the battery was ruptured or swelled.

### [Evaluation of Battery Performance—Discharge Capacity Test]

The fabricated nonaqueous electrolyte battery (lithium ion secondary battery 1) was evaluated for the battery performance. The battery performance was evaluated by a discharge capacity test. In the discharge capacity test, first, a charge-discharge cycle was repeated under the same conditions as those for the nail protrusion test described above, and the battery was charged to 4.2 V. After being charged, the battery was discharged at a constant current of 0.2 C, 0.5 C, 1.0 C, 2.0 C, and 3.0 C to an ending voltage of 2.7 V. The details of the testing conditions are indicated in Table 1. The battery was always charged at ⅓ C before being discharged at each current value indicated in Table 1. After the ending voltage was reached in the constant-current constant-voltage charge, constant-voltage charge was performed at the ending voltage. Charge was ended when the current reduces to an ending current value. The relative capacity obtained in this way was defined as the discharge capacity.

TABLE 1

| | | | Ending conditions | |
|---|---|---|---|---|
| | | Current value | Ending | Current |
| | Mode | (C rate) (A) | voltage | value |
| Charge | Constant current − | 1/3 C | 4.2 V | 0.01 C |
| | constant voltage | | | |
| | charge | | | |
| Discharge | Constant current | 0.2 C (10 A) | 2.7 V | — |
| | discharge | | | |
| | Constant current | 0.5 C (25 A) | 2.7 V | — |
| | discharge | | | |
| | Constant current | 1.0 C (50 A) | 2.7 V | — |
| | discharge | | | |
| | Constant current | 2.0 C (100 A) | 2.7 V | — |
| | discharge | | | |
| | Constant current | 3.0 C (150 A) | 2.7 V | — |
| | discharge | | | |

### EXAMPLES

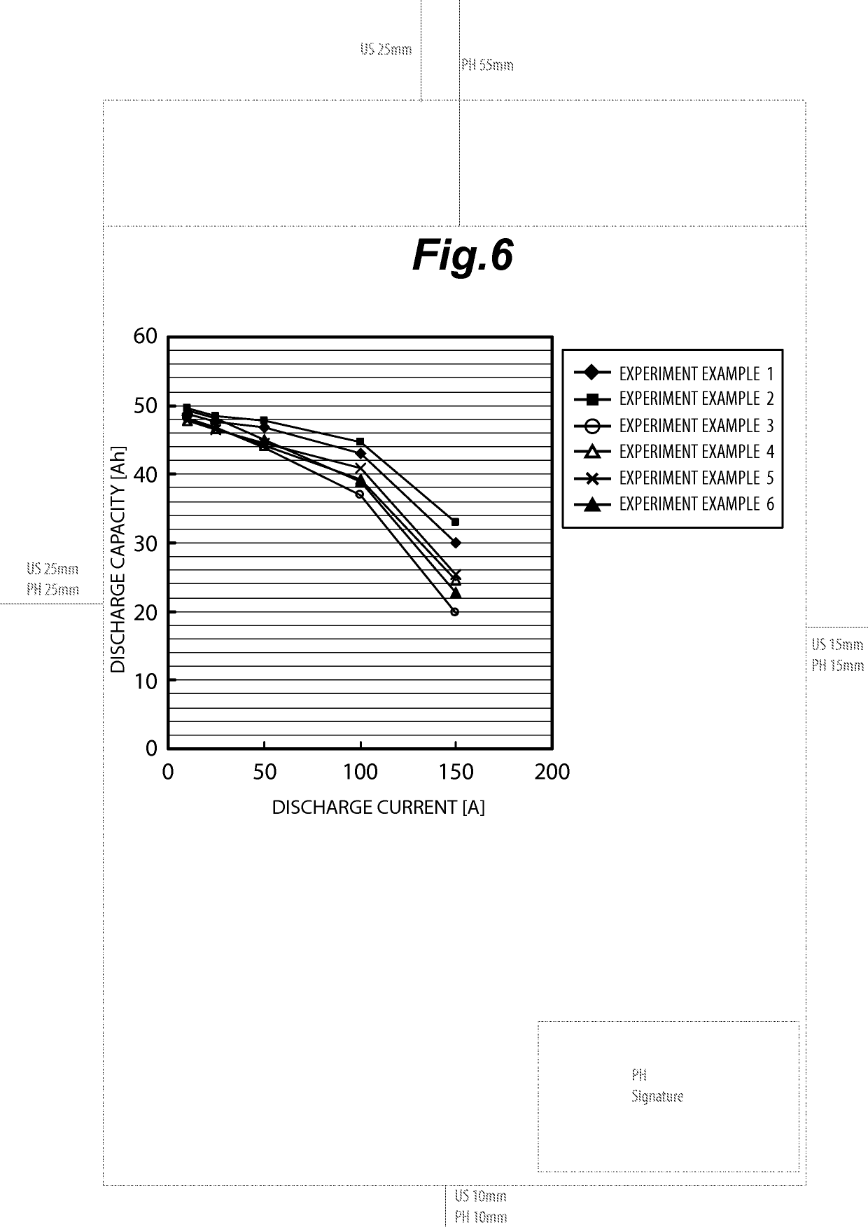

The nonaqueous electrolyte battery (lithium ion secondary battery 1) was examined for the flame retardant properties and the battery performance. Specifically, the state of fire/smoke generation from the battery was verified from the results of the nail penetration test and variations in discharge capacity were verified from the discharge capacity test for Experiment Examples 1 to 6 described below. The results are indicated in Table 2 and FIG. 6.

### Experiment Example 1

The tests were conducted on a battery including separators which do not have a protective layer or flame retardant layer formed on the surfaces of the separators.

### Experiment Example 2

The tests were conducted on a battery including separators which have only a front-side protective layer formed on the front surfaces of the separators.

### Experiment Example 3

The tests were conducted on a battery including separators which have a protective layer containing flame retardant dissolvable in an electrolyte as the separator described in Patent Document 1.

### Experiment Example 4

The tests were conducted on a battery including separators in which the front-side flame retardant layer 49 was formed on the entire front surface 47A of the front-side protective layer 47 as the separator 43 illustrated in FIGS. 2 and 7. The content of the cyclic phosphazene compound discussed above contained as flame retardant in the front-side flame retardant layer 49 was 15% by weight with respect to 100% by weight of the positive active material of the positive electrode.

### Experiment Example 5

The tests were conducted on a battery including separators in which stripes of the front-side flame retardant layer 49 were formed on the front surface of the front-side protective layer 47 such that a part of the front-side protective layer 47 is exposed as the separator 43 shown in FIGS. 2 and 8. The surface area of the front-side flame retardant layer 49 was about 50% with respect to the surface area of the front-side protective layer 47.

### Experiment Example 6

The tests were conducted on a battery including separators in which the front-side protective layer 147 and the front-side flame retardant layer 149 were formed on the front surface 145A of the porous base material 145 and not a back-side protective layer but only the back-side flame retardant layer 151 was formed as the separator 143 illustrated in FIG. 3.

In Experiment Examples 2 to 6, the separators were disposed such that the protective layer faced the positive electrode.

In Table 2, the flame retardant properties were evaluated as “∘” (good) if the lithium ion secondary battery 1 did not generate fire or smoke, and as “x” (poor) if the lithium ion secondary battery 1 generated fire or smoke. In addition, the battery performance was evaluated as “∘” (good) if the reduction in discharge capacity was relatively small with reference to the battery in which a protective layer or flame retardant layer was not formed on the surfaces of the porous base material (Experiment Example 1), as “x” (poor) if the reduction in discharge capacity was relatively large, and as “Δ” (slightly poor) if the reduction in discharge capacity was relatively slightly large.

Further, comprehensive evaluation was performed based on the evaluation results for the flame retardant properties and the battery performance. Specifically, the comprehensive evaluation was determined as “∘” (good) if both the flame retardant properties and the battery performance were evaluated as “∘”. The comprehensive evaluation was determined as “x” (poor) if at least one of the flame retardant properties and the battery performance was evaluated as “x”. The comprehensive evaluation was determined as “Δ” (slightly poor) if neither the flame retardant properties nor the battery performance was evaluated as “x” but at least one of the flame retardant properties and the battery performance was evaluated as “Δ”.

TABLE 2

| | Flame retardant | | Battery performance | | | | | | |
|---|---|---|---|---|---|---|---|---|---|
| | properties | | (discharge capacity | | | | | | |
| | Fire/ | | in Ah) | | | | | | Comprehensive |
| | smoke | Evaluation | 0.2 C | 0.5 C | 1.0 C | 2.0 C | 3.0 C | Evaluation | evaluation |
| Exp. Ex. 1 | Smoke | x | 48.8 | 47.6 | 46.8 | 43.0 | 30.0 | ∘ | x |
| Exp. Ex. 2 | Smoke | x | 49.6 | 48.4 | 47.8 | 44.7 | 33.0 | ∘ | x |
| Exp. Ex. 3 | No | ∘ | 48.1 | 46.9 | 43.9 | 37.0 | 19.7 | Δ | Δ |
| Exp. Ex. 4 | No | ∘ | 47.8 | 46.6 | 44.1 | 39.2 | 24.5 | ∘ | ∘ |
| Exp. Ex. 5 | No | ∘ | 47.7 | 46.5 | 44.5 | 40.8 | 25.4 | ∘ | ∘ |
| Exp. Ex. 6 | No | ∘ | 49.3 | 48.1 | 44.9 | 38.9 | 22.7 | ∘ | ∘ |

As seen from Table 2 and FIG. 6, in the example in which a protective layer or flame retardant layer was not formed on the surfaces of the separators as in the battery according to Experiment Example 1, the battery performance was good, but the flame retardant properties were poor (comprehensive evaluation: x). Also in the example in which not a front-side flame retardant layer but only a front-side protective layer was formed on the front surfaces of the separators as in the battery according to Experiment Example 2, in addition, the battery performance was good, but the flame retardant properties were poor (comprehensive evaluation: x). In the battery in which a protective layer containing flame retardant was formed on the front surface of the separator (a battery including the separator according to the related art of the present invention) as in the battery according to Experiment Example 3, further, the flame retardant properties were good, but the battery performance was slightly poor (comprehensive evaluation: Δ).

In the battery including separators in which a front-side flame retardant layer was formed on the entire front surface of a front-side protective layer as in the battery according to Experiment Example 4, in contrast, both the flame retardant properties and the battery performance were good (comprehensive evaluation: ∘). Also in the battery including separators in which stripes of a front-side flame retardant layer were formed on the front surface of a front-side protective layer as in the battery according to Experiment Example 5, in addition, both the flame retardant properties and the battery performance were good (comprehensive evaluation: ∘) as with the battery according to Experiment Example 4. In the battery including separators in which a protective layer and a flame retardant layer were provided on the front side and only a flame retardant layer was provided on the back side as in the battery according to Experiment Example 6, both the flame retardant properties and the battery performance were good (comprehensive evaluation: ∘) as with the battery according to Experiment Example 4.

From these results, it is found that to render a lithium ion secondary battery in which a front-side protective layer was formed flame-retardant, a reduction in discharge capacity (a reduction in battery performance) is suppressed better if a front-side flame retardant layer containing solid flame retardant is formed on the front surface of a front-side protective layer as in the battery according to Experiment Example 4. It is considered that the battery performance of the battery (battery according to Experiment Example 3) in which a front-side protective layer contains therein flame retardant dissolvable in an electrolyte as in the battery according to the related art was reduced because the flame retardant in the front-side protective layer was melted (decomposed) inside the battery to reduce the mechanical strength of the front-side protective layer (reduce the heat resistance) to thermally deform or thermally contract the separators. It is also considered that the battery performance of the battery according to Experiment Example 3 was reduced because the flame retardant decomposed in the electrolyte impaired the ion permeability (ion conductivity). In contrast, it is considered that a reduction in battery performance of the batteries (batteries according to Experiment Examples 4 and 5) including the separator according to the present invention in which a front-side protective layer does not contain front-side flame retardant and a front-side flame retardant layer containing solid flame retardant is formed on the front-side protective layer was suppressed because the protective layer was not broken and minute holes in the protective layer were not blocked even when an abnormal amount of heat was generated.

Specifically, in the battery according to Experiment Example 4, assuming that the positive electrode tends to be hot because of discharge, the separators 43 are disposed such that the front surface 45A of the porous base material 45 faces the positive electrode and the back surface 45B of the porous base material 45 faces the negative electrode (see FIG. 2). In the battery including such separators, the front-side flame retardant layer 49 formed on the front surface 47A of the front-side protective layer 47 releases the solid flame retardant as dissolved in the electrolyte when an abnormal amount of heat is generated, but the front-side flame retardant layer 49 keeps containing the flame retardant in a normal state. Thus, the mechanical strength of the front-side protective layer 47 remains unchanged. Therefore, it is considered that the flame retardant in the front-side flame retardant layer 49 is dissolved for the positive electrode, which may generate fire when the battery generates an abnormal amount of heat, to trap radicals generated from the positive electrode at the surface of joint with the positive electrode to exhibit flame retardant properties without reducing the battery performance in a normal state.

In addition, the separator illustrated in FIG. 2 (Experiment Example 4) may be replaced with the separator illustrated in FIG. 3. In this case, the separators 143 may be disposed such that the front-side flame retardant layer 149 on the front surface 145A side of the porous base material 145 faces the positive electrode and the back-aide flame retardant layer 151 on the back surface 145B side of the porous base material 145 faces the negative electrode. In the configuration illustrated in FIG. 3, the back-side flame retardant layer 151 is formed on the back surface 145E of the porous base material 145. Therefore, the front-side protective layer 147 is not broken at normal times, and higher flame retardant properties can be exhibited by the presence of the front-side flame retardant layer 149 and the back-side flame retardant layer 151.

Further, the separator of FIG. 3 may be replaced with the separator (see FIG. 4) obtained by removing the front-side flame retardant layer 149 from the front surface 147A of the front-side protective layer 147 of the separator illustrated in FIG. 3. In this case, the front-side protective layer 247 is formed on the front surface 245A of the porous base material 245, and the back-side flame retardant layer 251 is formed on the back surface 245B of the porous base material 245. Also in this case, the front-side protective layer 247 is not broken at normal times, and higher flame retardant properties can be exhibited by the presence of the back-side flame retardant layer 251.

If the negative electrode tends to be hot because of discharge, the separators 43, 143, or 243 of FIGS. 2 to 4 may be disposed in the battery such that the front-side flame retardant layer 49 or 149 on the front surface 245A or 145A, or the back-side flame retardant layer 251 of the porous base material 45, 145, or 245 faces the negative electrode.

If both the positive electrode and the negative electrode tend to be hot because of discharge, or if it is unclear which electrode tends to be hot, the separators 343 in which the front-side protective layer 347 and the front-side flame retardant layer 349 are formed on the front surface 345A of the porous base material 345 and the back-side protective layer 350 and the back-side flame retardant layer 351 are formed on the back surface 345B of the porous base material 345, such as the separator 343 structured as illustrated in FIG. 5, are preferably used in the battery.

Experiment Example 5 demonstrates that the flame retardant properties can be improved and a reduction in battery performance (discharge capacity) can be prevented even if the front-side flame retardant layer is partially formed on the front surface of the front-side protective layer such that a part of the front-side protective layer is exposed. That is, it is found that a battery can be rendered flame-retardant while suppressing a reduction in discharge capacity without forming a flame retardant layer over the entire front surface of a protective layer as in Experiment Example 4. Thus, partially forming a flame retardant layer as in Experiment Example 5 can substantially reduce the use amount of a flame retardant, and thus can reduce the production cost.

Also in the battery including separators (the separator of FIG. 4) in which a front-side flame retardant layer was not formed on a front-side protective layer of the separator and only a back-side flame retardant layer was formed as in the battery according to Experiment Example 6, both the flame retardant properties and the battery performance were good (comprehensive evaluation: ∘).

Next, the nonaqueous electrolyte battery (lithium ion secondary battery 1) was examined for the relationship between the content of the flame retardant contained in the front-side flame retardant layer and the back-side flame retardant layer and the flame retardant properties and the battery performance. Specifically, the state of fire/smoke generation from the battery was verified from the results of the nail penetration test and the high-rate discharge capacity (%) was verified from the results of the discharge capacity test for Experiment Examples 7 to 13 described below to examine the optimum content of the flame retardant contained in the flame retardant layer. The content of the flame retardant contained in the flame retardant layer has been adjusted based on the conditions for Experiment Example 4 discussed above (a case where a front-side flame retardant layer is formed over the entire front surface of a front-side protective layer), and is indicated by the unit of % by weight with respect to the weight of the positive active material. The results are indicated in Table 3.

### Experiment Example 7

Not a front-side flame retardant layer but only a front-side protective layer was formed on the front surfaces of the separators. That is, the content of the flame retardant was 0% by weight. This example is the same as Experiment Example 2 discussed above.

### Experiment Example 8

A front-side flame retardant layer was formed such that the content of the flame retardant was 1.0% by weight.

### Experiment Example 9

A front-side flame retardant layer was formed such that the content of the flame retardant was 2.5% by weight.

### Experiment Example 10

A front-side flame retardant layer was formed such that the content of the flame retardant was 5.0% by weight.

### Experiment Example 11

A front-side flame retardant layer was formed such that the content of the flame retardant was 10.0% by weight.

### Experiment Example 12

A front-side flame retardant layer was formed such that the content of the flame retardant was 15.0% by weight. This example is the same as Experiment Example 4 discussed above.

### Experiment Example 13

A front-side flame retardant layer was formed such that the content of the flame retardant was 20.0% by weight.

Also in Experiment Examples 7 to 13, the separators were disposed such that the front-side flame retardant layer faced the positive electrode.

In Table 3, as in Table 2, the flame retardant properties were evaluated as “∘” (good) if the lithium ion secondary battery (cylindrical battery) 1 did not generate fire or smoke, and as “x” (poor) if the lithium ion secondary battery 1 generated tire or smoke. In addition, the battery performance was evaluated as “∘” (good) if the high-rate discharge capacity was relatively large (70% or more) with respect to the high-rate discharge capacity for a case where a protective layer or flame retardant layer was not formed on the surfaces of the ceramic (Experiment Example 7) being defined as 100%, as “x” (poor) if the high-rate discharge capacity was relatively small, and as “Δ” (slightly poor) if the high-rate discharge capacity was relatively slightly small. Further, also in Table 3, as in Table 2, comprehensive evaluation was performed based on the evaluation results for the flame retardant properties and the battery performance.

TABLE 3

| | | | | Battery performance | | |
|---|---|---|---|---|---|---|
| | Flame | Flame retardant | | High-rate | | |
| | retardant | properties | | discharge | | |
| | (% by | Fire/ | | capacity | | Comprehensive |
| | weight) | smoke | Evaluation | (%) | Evaluation | evaluation |
| Exp. Ex. 7 | — | Yes | x | 100 | ∘ | x |
| Exp. Ex. 8 | 1.0 | Yes | x | 98 | ∘ | x |
| Exp. Ex. 9 | 2.5 | No | ∘ | 93 | ∘ | ∘ |
| Exp. Ex. 10 | 5.0 | No | ∘ | 89 | ∘ | ∘ |
| Exp. Ex. 11 | 10.0 | No | ∘ | 84 | ∘ | ∘ |
| Exp. Ex. 12 | 15.0 | No | ∘ | 80 | ∘ | ∘ |
| Exp. Ex. 13 | 20.0 | No | ∘ | 67 | Δ | Δ |

As indicated in Table 3, the battery performance (high-rate discharge capacity) was good but the flame retardant properties were poor (comprehensive evaluation: x) if the content of the flame retardant was in the range of 0 to 1.0% by weight with respect to the weight of the positive active material (Experiment Examples 7 and 8). Meanwhile, the flame retardant properties were good but the battery performance was slightly poor (comprehensive evaluation: Δ) if the content of the flame retardant was 20.0% by weight (Experiment Example 13). In contrast, both the flame retardant properties and the battery performance were good if the content of the flame retardant contained in the flame retardant layer was in the range of 2.5 to 15.0% by weight with respect to the weight of the positive active material (Experiment Examples 9 to 12). From these results, it is found that the content of the flame retardant contained in the flame retardant layer is preferably in the range of 2.5 to 15.0% by weight with respect to the weight of the positive active material (Experiment Examples 9 to 12) in order to render a nonaqueous electrolyte battery in which a protective layer is formed on the front surfaces of the separators flame-retardant while suppressing a reduction in battery performance. It is considered that the content of the flame retardant in the flame retardant layer was too small to exhibit sufficient flame retardant properties if the content of the flame retardant contained in the flame retardant layer was less than 2.5% by weight with respect to the weight of the positive active material (Experiment Examples 7 and 8). Meanwhile, it is considered that the content of the flame retardant in the flame retardant layer was so large that the flame retardant impaired the ion permeability in the flame retardant layer to reduce the high-rate discharge capacity if the content of the flame retardant contained in the flame retardant layer was more than 15.0% by weight with respect to the weight of the positive active material (Experiment Example 13).

Next, the nonaqueous electrolyte battery (lithium ion secondary battery 1) was examined for the relationship between the area of the flame retardant layer (area of a defined portion as seen in plan) and the flame retardant properties of the battery and the battery performance. Specifically, the state of fire/smoke generation from the battery was verified from the results of the nail penetration test and the high-rate discharge capacity (%) was verified from the results of the discharge capacity test for Experiment Examples 14 to 18 described below to examine the lower limit value of the area of the flame retardant layer with which good flame retardant properties and battery performance were obtained. The area of the flame retardant layer is indicated in terms of proportion (%) with respect to the area of the protective layer. In addition, the thickness of the flame retardant layer has been adjusted to about 70 μm. The results are indicated in Table 4.

### Experiment Example 14

A front-side flame retardant layer was formed over the entire front surface of a front-side protective layer. That is, the front-side flame retardant layer was formed such that the area of the front-side flame retardant layer was 100% with respect to the area of the front-side protective layer. The content of the cyclic phosphazene compound contained as flame retardant in the front-side flame retardant layer was 15.0% by weight with respect to the weight of the positive active material of the positive electrode. This example is the same as Experiment Example 4 (Experiment Example 12) discussed above.

### Experiment Example 15

A front-side flame retardant layer was formed such that the area of the front-side flame retardant layer was 90% with respect to the area of a front-side protective layer. The content of the cyclic phosphazene compound contained as flame retardant in the front-side flame retardant layer was 12.0% by weight with respect to the weight of the positive active material of the positive electrode.

### Experiment Example 16

A front-side flame retardant layer was formed such that the area of the front-side flame retardant layer was 60% with respect to the area of a front-side protective layer. The content of the cyclic phosphazene compound contained as flame retardant in the front-side flame retardant layer was 9.0% by weight with respect to the weight of the positive active material of the positive electrode.

### Experiment Example 17

A front-side flame retardant layer was formed such that the area of the front-side flame retardant layer was 50% with respect to the area of a front-side protective layer. The content of the cyclic phosphazene compound contained as flame retardant in the front-side flame retardant layer was 7.5% by weight with respect to the weight of the positive active material of the positive electrode.

### Experiment Example 18

A front-side flame retardant layer was formed such that the surface area of the front-side flame retardant layer was 40% with respect to the area of a front-side protective layer. The content of the cyclic phosphazene compound contained as flame retardant in the front-side flame retardant layer was 6.0% by weight with respect to the weight of the positive active material of the positive electrode.

Also in Experiment Examples 14 to 18, the separators were disposed such that the protective layer faced the positive electrode.

In Table 4, as in Table 2 and Table 3, the flame retardant properties were evaluated as “∘” (good) if the lithium ion secondary battery (cylindrical battery) 1 did not generate fire or smoke, and as “x” (poor) if the lithium ion secondary battery 1 generated fire or smoke. In addition, the battery performance was evaluated as “∘” (good) if the high-rate discharge capacity (%) was relatively large (more than 100%) with respect to the discharge capacity for a case where the area of the flame retardant layer was 100% with respect to the area of the protective layer (Experiment Example 14) being defined as 100%, and as “x” (poor) if the high-rate discharge capacity (%) was relatively small. Further, also in Table 4, as in Table 2, comprehensive evaluation was performed based on the evaluation results for the flame retardant properties and the battery performance.

TABLE 4

| | Surface area | | | Battery performance | | |
|---|---|---|---|---|---|---|
| | of flame | Flame retardant | | High-rate | | |
| | retardant | properties | | discharge | | Comprehensive |
| | layer (%) | Fire/smoke | Evaluation | capacity (%) | Evaluation | evaluation |
| Exp. Ex. 14 | 100 | No | ∘ | 100 | — | — |
| Exp. Ex. 15 | 80 | No | ∘ | 105 | ∘ | ∘ |
| Exp. Ex. 16 | 60 | No | ∘ | 112 | ∘ | ∘ |
| Exp. Ex. 17 | 50 | Smoke | x | 124 | ∘ | x |
| Exp. Ex. 18 | 40 | Smoke | x | 127 | ∘ | x |

As indicated in Table 4, the flame retardant properties and the battery performance were good (comprehensive evaluation: ∘) if the area of the flame retardant layer was 80% to 60% (Experiment Examples 15 and 16) compared to a case where the area of the protective layer was 100% (Experiment Example 14). This is considered to be because an exposed portion in which a flame retardant layer was not formed was formed on the surfaces of the separators (or the protective layer) and the exposed portion enhanced the ion permeability to increase the ion permeability of the separators as a whole to improve the battery performance. However, the battery performance was good but the flame retardant properties were poor (comprehensive evaluation: x) if the area of the flame retardant layer was 50% to 40% (Experiment Examples 17 and 18). That is, it is found to be necessary that the flame retardant layer should be formed such that the area of the flame retardant layer was at least 60% with respect to the area of the nonaqueous electrolyte battery separator (protective layer) in order to obtain good flame retardant properties and battery performance. It is considered that sufficient flame retardant properties could not be obtained because the content of the flame retardant itself was small if the area of the flame retardant layer was less than 60% (Experiment Examples 17 and 18).

In the embodiments and the examples described above, the electrode group 9 is formed as a wound member. However, it is a matter of course that the present invention may also be applied to a stacked lithium ion secondary battery in which the electrode group is formed by stacking the electrodes.

Embodiments and examples of the present invention have been specifically described above. However, the present invention is not limited to the embodiments and the examples, and may be changed based on the technical concept of the present invention as a matter of course.

### INDUSTRIAL APPLICABILITY

According to the present invention, a front-side flame retardant layer containing solid flame retardant having a melting point that does not allow the flame retardant to be dissolved when the battery is at a normal temperature is formed on the front surface of a front-side protective layer. Thus, a flame retardant layer that is separate from a protective layer can be formed on the front surface of a separator. Therefore, flame retardant is not contained in the protective layer. Thus, the mechanical strength of the protective layer is not reduced even if a part or all of the flame retardant is melted or decomposed because of a rise in internal temperature, which prevents thermal deformation or thermal contraction of the separator. As a result, a short circuit is unlikely to be caused through the separator between electrodes, which suppresses a reduction in battery performance. Moreover, when an abnormal amount of heat is generated, the flame retardant in the flame retardant layer provided separately from the protective layer is dissolved in a nonaqueous electrolyte to trap radicals generated in the battery to exhibit flame retardant properties. Thus, according to the present invention, a nonaqueous electrolyte battery can be rendered flame-retardant while maintaining the battery performance.

### DESCRIPTION OF REFERENCE NUMERALS

1 lithium ion secondary battery (cylindrical battery)
3 battery container
5 battery lid
7 axial core
9 electrode group
11 positive electrode lead piece
13 negative electrode lead piece
15 positive electrode pole
17 flange portion of positive electrode pole
19 negative electrode pole
21 flange portion of negative electrode pole
23 insulating coating
25 first ceramic washer
27 terminal portion (positive electrode)
29 terminal portion (negative electrode)
31 second ceramic washer
33 nut
35 metal washer
36 cleavage valve
37 projecting portion
39 O ring
41 liquid injection plug
43, 143, 243, 343 separator
45, 145, 245, 345 porous base material
45A, 145A, 245A, 345A front surface of porous base material
45B, 145B, 245B, 345B bank surface of porous base material
47, 147, 247, 347 front-side protective layer
47A, 147A, 247A, 347A front surface of front-side protective layer
49, 149, 249, 349 front-side flame retardant layer
350 back-side protective layer
151, 251, 351 back-side flame retardant layer

1-13. (canceled)

14. A nonaqueous electrolyte battery separator comprising:
a porous base material made of a polyolefin-based resin;
a porous front-side protective layer formed on a front surface of the porous base material to protect the porous base material such that the porous base material is not thermally deformed or thermally contracted;
a porous front-side flame retardant layer formed on the front-side protective layer and containing solid flame retardant having a melting point lower than an ignition temperature of a nonaqueous electrolyte; and
the front-side flame retardant layer is formed such that a surface area of the front-side retardant layer is 60 to 80% per a surface area of the font-side protective layer.

15. The nonaqueous electrolyte battery separator according to claim 14, further comprising:
a porous back-side flame retardant layer formed on a back surface of the porous base material and containing solid flame retardant having a melting point lower than an ignition temperature of the nonaqueous electrolyte.

16. The nonaqueous electrolyte battery separator according to claim 14, further comprising:
a porous back-side protective layer formed on a back surface of the porous base material to protect the porous base material such that the porous base material is not thermally deformed or thermally contracted.

17. The nonaqueous electrolyte battery separator according to claim 16, further comprising:
a back-side flame retardant layer formed on the back-side protective layer and containing solid flame retardant having a melting point lower than the ignition temperature of the nonaqueous electrolyte.

18. A nonaqueous electrolyte battery separator comprising:
a porous base material made of a polyolefin-based resin;
a porous front-side protective layer formed on a front surface of the porous base material to protect the porous base material such that the porous base material is not thermally deformed or thermally contracted;
a porous back-side flame retardant layer formed on a back surface of the porous base material and containing solid flame retardant having a melting point lower than an ignition temperature of the nonaqueous electrolyte; and
the back-side flame retardant layer is formed such that a surface area of the back-side retardant layer is 60 to 80% per a surface area of the back surface of the porous base material.

19. The nonaqueous electrolyte battery separator according to claim 14, wherein
the solid flame retardant is a cyclic phosphazene compound having a melting point that is equal to or more than 90° C. and that is less than the ignition temperature.

20. The nonaqueous electrolyte battery separator according to claim 17, wherein:
the solid flame retardant is a cyclic phosphazene compound having a melting point that is equal to or more than 90° C. and that is less than the ignition temperature; and
the content of the cyclic phosphazene compound is 2.5 to 15.0% by weight with respect to the weight of an active material contained in an electrode provided to face the front-side flame retardant layer or the back-side flame retardant layer.

21. The nonaqueous electrolyte battery separator according to claim 14, wherein
the front-side protective layer contains therein a plurality of fillers bound to the front surface of the porous base material by a binder and having a melting point equal to or more than 120° C.

22. The nonaqueous electrolyte battery separator according to claim 17, wherein
the back-side protective layer contains therein a plurality of fillers bound to the back surface of the porous base material by a binder and having a melting point equal to or more than 120° C.

23. The nonaqueous electrolyte battery separator of claim 14, wherein
the front-side flame retardant layer is formed in stripes.

24. The nonaqueous electrolyte battery separator of claim 15, wherein
the back-side flame retardant layer is formed in stripes.

25. A nonaqueous electrolyte battery comprising the nonaqueous electrolyte battery separator according to claim 14.

26. A nonaqueous electrolyte battery comprising the nonaqueous electrolyte battery separator according to claim 14, wherein
the front-side flame retardant layer is formed in stripes.

27. A nonaqueous electrolyte battery comprising the nonaqueous electrolyte battery separator according to claim 15, wherein
the back-side flame retardant layer is formed in stripes.

28. A nonaqueous electrolyte battery comprising the nonaqueous electrolyte battery separator according to claim 14, wherein
the front-side flame retardant layer faces a positive electrode, and the back surface of the porous base material faces a negative electrode.

29. A nonaqueous electrolyte battery comprising the nonaqueous electrolyte battery separator according to claim 15, wherein:
the front-side flame retardant layer faces a positive electrode, and the back surface of the porous base material faces a negative electrode; and
the front-side flame retardant layer is formed in stripes.

30. A nonaqueous electrolyte battery comprising the nonaqueous electrolyte battery separator according to claim 15, wherein
the front-side flame retardant layer faces a positive electrode, and the back-side flame retardant layer faces a negative electrode.

31. A nonaqueous electrolyte battery comprising the nonaqueous electrolyte battery separator according to claim 15, wherein:
the front-side flame retardant layer faces a positive electrode, and the back-side flame retardant layer faces a negative electrode; and
the front-side flame retardant layer is formed in stripes.

32. A nonaqueous electrolyte battery comprising the nonaqueous electrolyte battery separator according to claim 15, wherein:
the front-side flame retardant layer faces a positive electrode, and the back-side flame retardant layer faces a negative electrode; and
the back-side flame retardant layer is formed in stripes.
